(19) United States
(12) Patent Application Publication
(10) Pub. No.: US 2012/0168429 A1
(43) Pub. Date: Jul. 5, 2012

(54) HEATER FOR FIXING DEVICE AND FIXING DEVICE AND IMAGE FORMING APPARATUS HAVING THE SAME

(75) Inventors: Young-geun KIM, Suwon-si (KR); Hwan-guem KIM, Seoul (KR); Jong-oh KIM, Seongnam-si (KR)

(73) Assignee: SAMSUNG ELECTRONICS CO., LTD., Suwon (KR)

(21) Appl. No.: 13/303,676

(22) Filed: Nov. 23, 2011

(30) Foreign Application Priority Data
Jan. 3, 2011 (KR) 2011-0000226

(51) Int. Cl. H05B 3/10

(52) U.S. Cl. 219/548

(57) ABSTRACT

A heater is provided with a bulb, a first heating element which has a negative temperature coefficient of resistance and a first rated heating power and forms a first coil in the bulb, a second heating element which has a positive temperature coefficient of resistance and a second rated heating power that is lower than the first rated heating power and is disposed in the bulb. The second heating element is placed adjacent to the first heating to heat the first heating element at an initial stage of a power supplying to the heater, thereby reducing resistance of the first heating element.

### CROSS-REFERENCE TO RELATED APPLICATIONS

This application claims priority under 35 U.S.C. §119 from Korean Patent Application No. 10-2011-0000226, filed on Jan. 3, 2011, in the Korean Intellectual Property Office, the disclosure of which is incorporated herein by reference in its entirety.

### BACKGROUND

1. Field

Apparatuses and methods consistent with exemplary embodiments relate to an image forming apparatus, and more particularly, to a fixing device used in the image forming apparatus.

2. Description of the Related Art

Image forming apparatuses such as printers, facsimiles, copiers, multi-function peripherals and so on form prescribed images on a printing medium by using an electronic photo method. In general, to form the images by using such the image forming apparatus, it has to be gone through a charging process, an exposing process, a developing process, a transferring process, and a fixing process.

A fixing device which is used during the fixing process fixes an unsettled toner on the printing medium by applying heat and pressure to the printing medium. This kind of the fixing device is generally composed with a heating unit and a pressing unit that are contacted to each other to form a fixing nip therebetween. When the printing medium passes through the fixing nip, the heat and pressure are transmitted to the printing medium and thus, the unsettled toner may be fixed.

In order to transmit heat to the printing medium, a heater is mounted in the heating unit. At present, a halogen lamp is widely used as the heater in the fixing device.

A tungsten filament is used in the halogen lamp, which keeps very low resistance at room temperature. Accordingly, at an initial stage where the power is supplied to the halogen lamp, an excessive inrush current occurs. The excessive inrush current may cause a radical voltage fluctuation and a flicker phenomenon.

One of the major qualities of the image forming apparatus is fast FPOT (first paper out time). For the fast FPOT, the heat energy which is generated by a heater located in the heating unit should be increased. However, if a large amount of power is supplied to the halogen lamp to increase the heat energy, the inrush current occurs excessively.

To resolve the above drawbacks, plural halogen lamps may be arranged inside the heating unit, however, this restricts the miniaturization of the fixing device. As per consumer demand, there is a trend of miniaturizing the image forming apparatus and thus, the size of the fixing device is getting smaller. Accordingly, the space required to mount the plural halogen lamps becomes insufficient. Therefore, it is imperative to develop a heater for the fixing device with which the miniaturization of the fixing device is available and the inrush current may be prevented.

### SUMMARY

Exemplary embodiments of the present disclosure address at least the above problems and/or disadvantages and other disadvantages not described above. Also, the present disclosure is not required to overcome the disadvantages described above, and an exemplary embodiment of the present disclosure may not overcome any of the problems described above.

According to an exemplary aspect of the present disclosure, there is provided a heater for a fixing device to provide heat to a printing medium, including a bulb, a first heating element which has a negative temperature coefficient of resistance and a first rated heating power and forms a first coil in the bulb, and a second heating element which has a positive temperature coefficient of resistance and a second rated heating power that is lower than the first rated heating power and is disposed in the bulb. The second heating element is placed adjacent to the first heating to heat the first heating element at an initial stage of a power supplying to the heater, thereby reducing resistance of the first heating element.

The first heating element may include a carbon filament, and the second heating element may include a tungsten filament.

The second heating element may include plural filaments which contact the first coil of the first heating element and extend along with a progress direction of the first coil of the first heating element in parallel to one another.

The heater may further include plural coupling members to attach the second heating element to the first heating element.

The plural coupling members may be disposed along with the progress direction of the first coil of the first heating element.

The second heating element may be joined to the first heating element.

The second heating element may extend along with the progress direction of the first coil of the first heating element.

The second heating element may be wound around the first coil of the first heating element.

The second heating element may form a second coil in the bulb.

The first coil may be disposed in the second coil.

The second coil may be disposed in the first coil.

The first coil and the second coil may have a same coil axis.

The first coil and the second coil may have a same coil radius, and the second coil may be placed to be offset from the first coil along with the coil axis.

Heating power of the heater may be between 600 W and 3000 W.

A first rated heating power of the first heating element may be 800 W, and a second rated heating power of the second heating element may be 500 W.

The first heating element and the second heating element may be electrically connected to each other in parallel.

The first heating element and the second heating element may be electrically connected to each other in series.

According to another aspect of the exemplary embodiment, an image forming apparatus and a fixing device for the image forming apparatus may include a heater which has the above mentioned characteristics.

### BRIEF DESCRIPTION OF THE DRAWINGS

The above and/or other aspects of the present disclosure will be more apparent by describing certain exemplary embodiments of the present disclosure with reference to the accompanying drawings, in which:

FIG. 1 schematically illustrates an image forming apparatus according to an exemplary embodiment;

FIG. 2 schematically illustrates a perspective view of a heater according to the exemplary embodiment;

FIG. 3 illustrates an enlarged portion of the heater depicted in FIG. 2;

FIG. 4 is a graph illustrating resistance according to a temperature variation of a carbon filament which is used in the exemplary embodiment;

FIG. 5 is a graph illustrating resistance according to a temperature variation of a tungsten filament which is used in the exemplary embodiment;

FIG. 6 is a graph illustrating a measured result with regard to resistance variation of a first heating element and a second heating element according to the exemplary embodiment;

FIG. 7 is a graph illustrating a measured result with regard to a heating power variation of a heater and a temperature variation of a heating roller according to the exemplary embodiment;

FIG. 8 is a graph illustrating a measured result with regard to a heating power variation of a heater and a temperature variation of a heating roller according to a standard embodiment to compare with the exemplary embodiment;

FIG. 9 is a graph illustrating a measured result with regard to a heating power variation of a heater and a temperature variation of a heating roller according to a second embodiment;

FIG. 10 schematically illustrates a heater according to a third embodiment;

FIG. 11 schematically illustrates a heater according to a fourth embodiment;

FIG. 12 schematically illustrates a heater according to a fifth embodiment;

FIG. 13 schematically illustrates a heater according to a sixth embodiment; and

FIG. 14 schematically illustrates a heater according to a seventh embodiment.

### DETAILED DESCRIPTION

Certain exemplary embodiments will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the disclosure. Thus, it is apparent that the present disclosure can be carried out without those specifically defined matters. Also, well-known functions or constructions are not described in detail since they would obscure the disclosure with unnecessary detail.

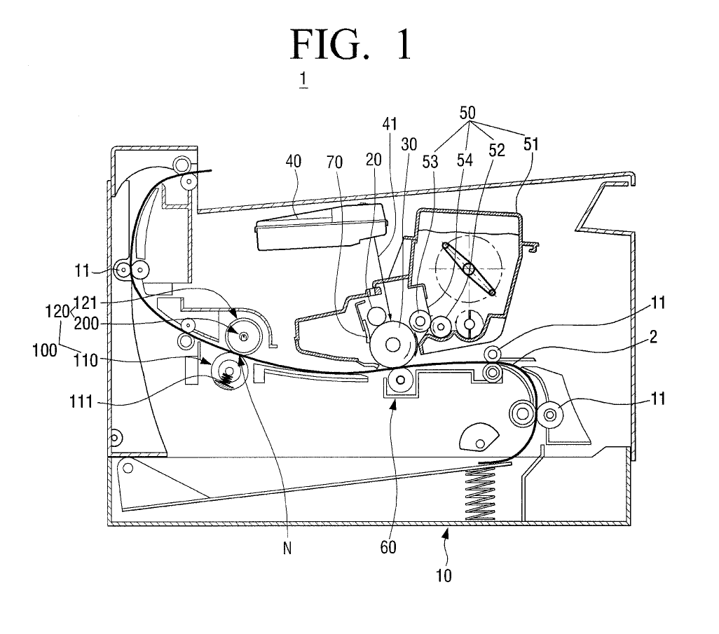

FIG. 1 schematically illustrates an image forming apparatus 1 according to an exemplary embodiment. The image forming apparatus 1 may be embodied by various apparatuses such as a printer, a fax machine, a copier, or a multi-function peripheral which form a prescribed image on a printing medium.

A feeding apparatus 10 may accommodate a printing medium such as the printing papers. The printing medium is transferred through a progress course 2 by a plurality of supplying rollers 11. A charging apparatus 20 may charge a photoreceptor 30 by a predetermined electric potential. A light scanning apparatus 40 may form an electrostatic latent image on the photoreceptor 30 which corresponds to a printing data by way of scanning a light 41 to the photoreceptor 30.

A developing apparatus 50 may form a toner image by supplying the toner to the photoreceptor 30 formed with the electrostatic latent image. The developing apparatus 50 may include a toner accommodation unit 51, a toner supplying roller 52, a developing roller 53 and a control blade 54.

The toner accommodation unit 51 accommodates a toner therein. The toner supplying roller 52 supplies the toner accommodated in the toner accommodation unit 51 to the developing roller 53, thereby forming a toner layer at the developing roller 53. The control blade 54 equalizes this toner layer. The toner layer placed on the developing roller 53 moves towards the electrostatic latent image which is formed at the photoreceptor 30 due to the potential difference and develops a toner image.

A transferring apparatus 60 may transfer the toner image which is formed at the photoreceptor 30 to the printing medium. A cleaning apparatus 70 may remove the toner which is remained at the photoreceptor 30 after the transferring process is completed.

A fixing device 100 may fix the unsettled toner which is located on the printing medium by applying the heat and the pressure onto the printing medium. The printing medium on which the toner is fixed is released to outside the image apparatus 1 by the plurality of supplying rollers 11, and this completes the printing process.

The fixing device 100 may include a pressing unit 110 and a heating unit 120. A fixing nip (N) is formed at a contacting section of the pressing unit 110 and the heating unit 120. The unsettled toner remains on the printing medium which has passed the transferring apparatus 60, and the unsettled toner on the printing medium may be fixed by the application of the heat and the pressure to the printing medium while the printing medium passes through the fixing nip (N).

The pressing unit 110 is pressed towards the heating unit 120 by an elastic member 111 so as to apply the pressure to the printing medium which has passed the fixing nip (N). The pressing unit 110 according to an exemplary embodiment is formed in a roller shape, however, the pressing unit 110 may be formed in a belt type.

The belt-typed pressing unit 110 may be easily achieved by those skilled in the art, so the detailed description thereof is omitted.

The heating unit 120 applies the heat to the printing medium which passes through the fixing nip (N) and may include a heating roller 121 and a heater 200 which is disposed inside the heating roller 121. The heater 200 generates heat to supply it to the printing medium, and the heat generated by the heater 200 is transmitted to the printing medium through the heating roller 121.

As the heating roller 121 may be heated at a high temperature, it is desirable to form the heating roller 121 with a heat resistance material. The heating unit 120 is formed in a roller type using the heating roller 121 according to an exemplary embodiment, however, the heating unit 120 may also be formed in a belt type. That is, in this case, a heating belt is used instead of the heating roller 121. The detailed description of the belt-typed heating unit 120 is omitted since it may be easily achieved by those skilled in the art.

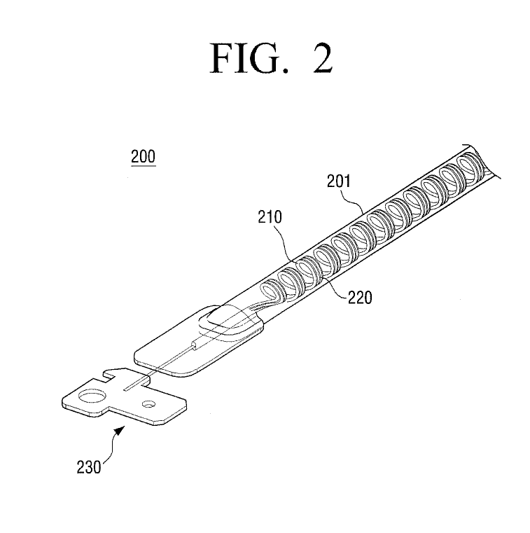

With reference to FIGS. 2 to 7, a further detailed description of the heater 200 is recited according to an exemplary embodiment.

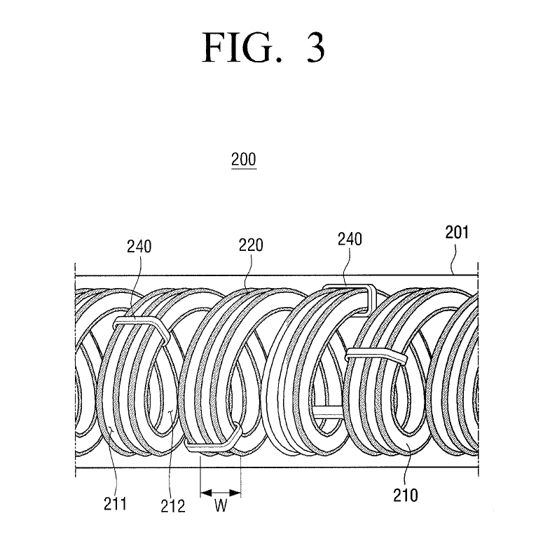

FIG. 2 schematically illustrates a perspective view of the heater 200 according to the exemplary embodiment, and FIG. 3 illustrates an enlarged portion of the heater 200 depicted in FIG. 2.

A bulb 201 is in a cylindrical shape and sealed with an inactive gas therein. The bulb 201 is formed with a heat resistance material, for example, a quartz glass.

First and second heating elements 210 and 220 are placed inside the bulb 201 and convert electric energy supplied from external power source to heat. The heat generated from the first and second heating elements 210 and 220 is transmitted to the printing medium which passes through the fixing nip (N) by using the heating roller 121 and fixes the unsettled toner.

The first heating element 210 forms a coil in the bulb 201 and may transmit the heat to the heating roller 121 evenly along the longitudinal direction of the heater 200. Here, the first heating element 210 has a negative temperature coefficient of resistance. In other words, resistance of the first heating element 210 has a characteristic of decreasing as the temperature increases. For instance, carbon may be a proper material to satisfy the above characteristic. In the exemplary embodiment, a carbon filament is used as the first heating element 210. However, this is merely an example and the first heating element 210 may be formed in various materials having a negative temperature coefficient of resistance.

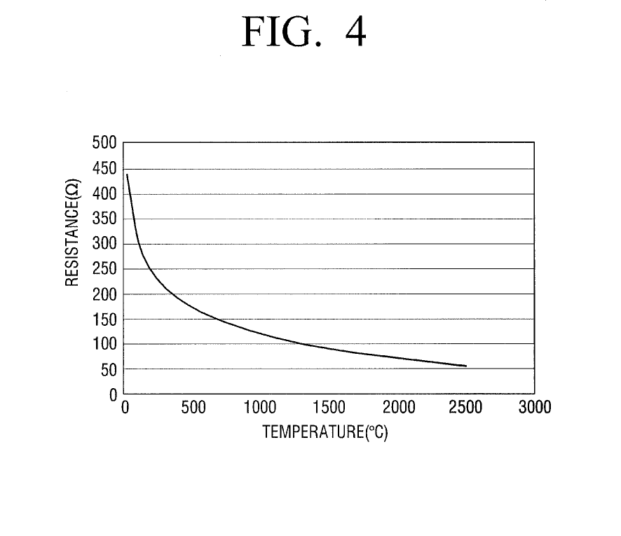

FIG. 4 is a graph illustrating resistance according to a temperature variation of a carbon filament which is used in the exemplary embodiment. In FIG. 4, a horizontal axis indicates temperature of the carbon filament and a vertical axis indicates resistance of the carbon filament. As shown in FIG. 4, resistance of the carbon filament decreases as the temperature increases. In particular, the carbon filament has a high resistance at a normal temperature.

The second heating element 220 placed in the bulb 201 has a positive temperature coefficient of resistance. In other words, resistance of the second heating element 220 has a characteristic of increasing as the temperature increases. For instance, tungsten may be a proper material to satisfy the above characteristic. In the exemplary embodiment a tungsten filament is used as the second heating element 220. However, this is merely an example and the second heating element 220 may be formed in various materials which have a positive temperature coefficient of resistance.

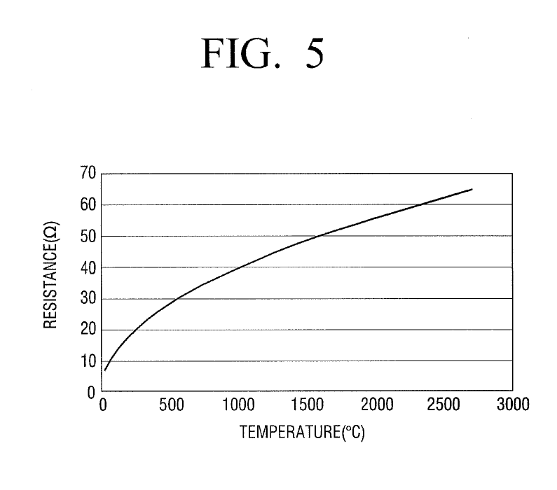

FIG. 5 is a graph illustrating resistance according to a temperature variation of a tungsten filament which is used in the exemplary embodiment. In FIG. 5, the horizontal axis indicates the temperature of the tungsten filament, and the vertical axis indicates resistance of the tungsten filament. As shown in FIG. 5, resistance of the tungsten filament increases as the temperature increases. In particular, the tungsten filament has low resistance at a normal temperature.

The first heating element 210 may be electrically connected to the second heating element 220 either in parallel or series. Referring to FIG. 2 again, a connector 230 is connected to an external power source to supply the power to the first and second heating elements 210 and 220. In FIG. 2, only one connector 230 is depicted, however, the same connector 230 which is not shown is placed at the opposite side of the heater 200.

Referring to FIG. 3, a plurality of coupling members 240 which are placed along the progress direction of the coil of the first heating element 210 attach the second heating element 220 to the first heating element 210. By using the plurality of coupling members, the second heating element 220 contacts the first heating element 210. The plurality of coupling members 240 is exposed to a high temperature, so it is desirable to form the plurality of coupling members with a heat resistant material.

As shown in FIG. 3, the second heating element 220 includes six tungsten filaments which contact the first heating element 210 in the exemplary embodiment. Among the six tungsten filaments, three filaments are disposed on an external surface 211 of the coil of the first heating element 210 and the remaining three filaments are disposed on an internal surface 212 of the coil of the first heating element 210. These six tungsten filaments are extended along the progress direction of the coil of the first heating element 210 in parallel to one another.

As the carbon filament which is used as the first heating element 210 in the exemplary embodiment has a relatively wide width (W), six tungsten filaments may be used. If the width of the carbon filament is narrow, less than six tungsten filaments may be used, and if the width of the carbon filament is wide enough, more than six tungsten filaments may be used. Also, the tungsten filament may be placed on only one of the surfaces between the external surface 211 and the internal surface 212 of the coil of the first heating element 210.

The rated heating power of the heater 200 according to the exemplary embodiment is set as 1300 W. Here, the rated heating power of the first heating element 210 is set as 800 W, and the rated heating power, of the second heating element 220 is designed to 500 W which is lower than the rated heating power of the first heating element 210. In other words, in the exemplary embodiment, the first heating element 210 is operated as the main heating element, and the second heating element 220 is operated as the subsidiary heating element. In particular, the rated heating power of the first heating element 210 which keeps a negative temperature coefficient of resistance is larger than the rated heating power of the second heating element 220 which keeps a positive temperature coefficient of resistance.

As illustrated in FIG. 4, the first heating element 210 which keeps a negative temperature coefficient of resistance has high resistance at a normal temperature, thereby enabling to restrain the occurrence of inrush current. Even if the heating power of the heater 200 is raised for the fast FPOT, as the heating power allotted to the first heating element 210 which keeps high resistance at a normal temperature is larger than the heating power allotted to the second heating element 220 which keeps low resistance at a normal temperature, excessive inrush current may be restrained. That is, if the first heating element 210 is not used or the heating power allotted to the first heating element 210 is smaller than the heating power allotted to the second heating element 220, a large amount of inrush current may occur by second heating element 220 which keeps low resistance at a normal temperature. The excessive inrush current is not generated in the heater 200 in that the rated heating power of the first heating element 210 is set as 800 W, and the rated heating power of the second heating element 220 is set as 500 W according to the exemplary embodiment.

However, owing to the existence of the first heating element 210 which keeps high resistance at a normal temperature, the reaction time of the heater 200 may be slowed down. That is, at an initial stage where the power source is supplied to the heater 200, the amount of heat generated by the first heating element 210 which holds high resistance at a normal temperature is not large enough and the time to reach the highest heating power of the first heating element 210 is delayed. It means that at the initial stage where the power is supplied to the heater 200, the heat transferred from the first heating element 210 to the heating roller 121 is small and therefore, the FPOT is delayed.

In order to improve the above phenomena, at the initial stage where the power source is supplied to the heater 200, the second heating element 220 which keeps low resistance at a normal temperature heats the first heating element 210. In other words, as the second heating element 220 keeps low resistance at a normal temperature, the second heating element 220 may generate a large amount of heat at the initial stage where the power source is supplied to the heater 200 as shown in FIG. 5. With reference to FIG. 3, the second heating element 220 contacts the first heating element 210 so that the heat generated from the second heating element 220 may be used to heat the first heating element 210. Because the first heating element 210 keeps a negative temperature coefficient of resistance, resistance of the first heating element 210 is lowered down quickly as the second heating element 220 heats the first heating element 210. Accordingly, the first heating element 210 may reach the maximum heating power within a short period of time.

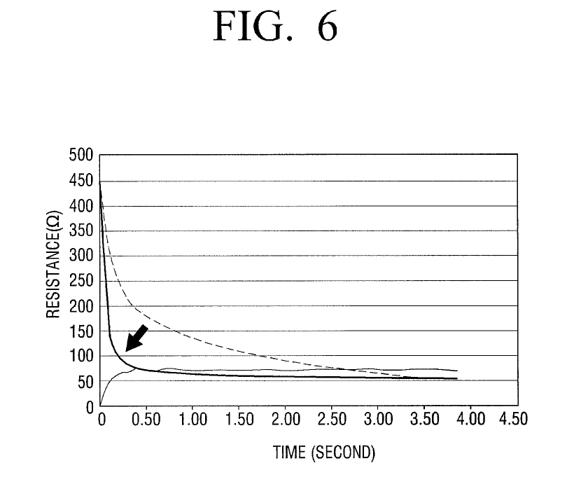

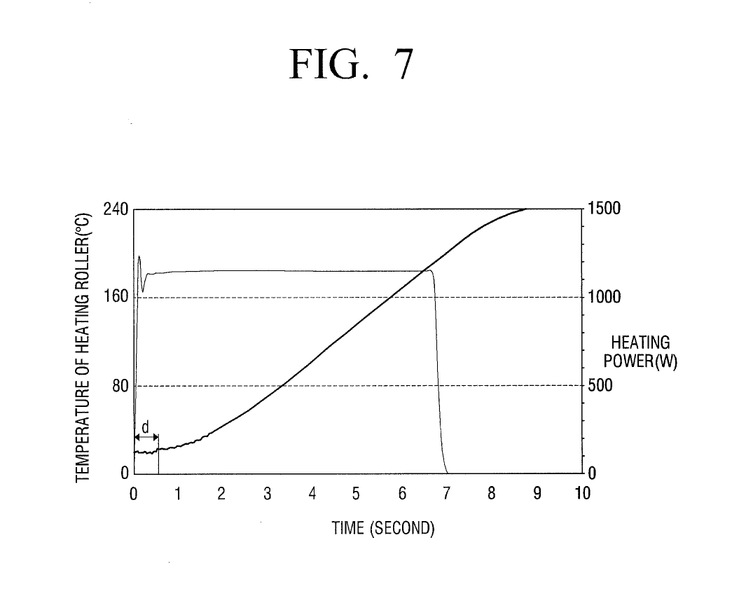

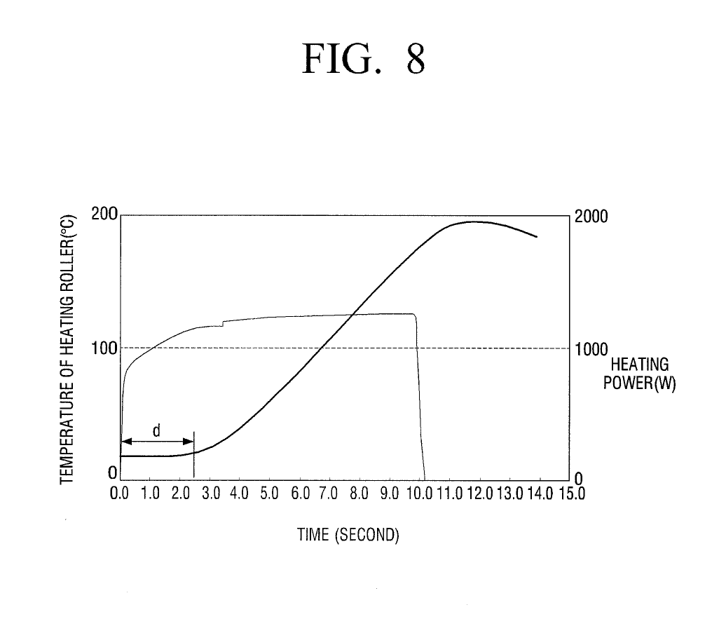

Referring to FIGS. 6 to 8, the operation procedure of the heater 200 will be described in more detail. FIGS. 6 and 7 are the graphs illustrating experimental results of the exemplary embodiment, and FIG. 8 is a graph illustrating an experimental result of the standard embodiment compared to the exemplary embodiment. In the standard embodiment, the second heating element 220 does not exist and only the first heating element 210 is used. To compare with the exemplary embodiment under the same condition, the rated heating power of the standard embodiment is set at 1300 W which is the same as that of the exemplary embodiment.

FIG. 6 is a graph illustrating a measured result with regard to a resistance variation of the first and second heating elements 210 and 220. A horizontal axis indicates the elapsed time from the power supply to the heater 200, and a vertical axis indicates resistance. In FIG. 6, resistance of the first heating element 210 is depicted as a bold line, and resistance of the second heating element 220 is depicted as a fine line. In FIG. 6, a dotted line represents resistance of the first heating element 210 if the second heating element 220 does not exist.

FIG. 7 is a graph illustrating a measured result with regard to a heating power variation of the heater 200 and a temperature variation of the heating roller 121. In FIG. 7, a horizontal axis indicates the elapsed time from the power supply time to the heater 200, a vertical axis on the left side indicates a temperature of the heating roller 121, and a vertical axis on the right side indicates the heating power of the heater 200. In FIG. 7, the heating power of the heater 200 is depicted as a fine line, and the temperature of the heating roller 121 is depicted as a bold line.

FIG. 8 is a graph illustrating an experimental result of a standard embodiment in the same way of FIG. 7.

As illustrated FIG. 8, it takes about 4 seconds to reach the highest heating power, and it takes about 2.5 seconds of the delay time (d) from the power supply time to the starting time of the temperature rise of the heating roller 121 in the standard embodiment. According to FIG. 7, the time to reach the highest heating power is considerably shortened and the delay time (d) from the power supply time to the starting time of the temperature rise of the heating roller 121 takes about 0.5 seconds in the exemplary embodiment. Such difference may reduce resistance of the first heating element 210 in the exemplary embodiment since the second heating element 220 heats the first heating element 210 which keeps a negative temperature coefficient of resistance.

FIG. 6 shows the above phenomenon clearly. When the second heating element 220 heats the first heating element 210 at the initial stage of the power supply to the heater 200, resistance of the first heating element 210 which keeps a negative temperature coefficient of resistance is sharply reduced. According to the sharp reduction of resistance of the first heating element 210, the first heating element 210 may reach the highest heating power quickly.

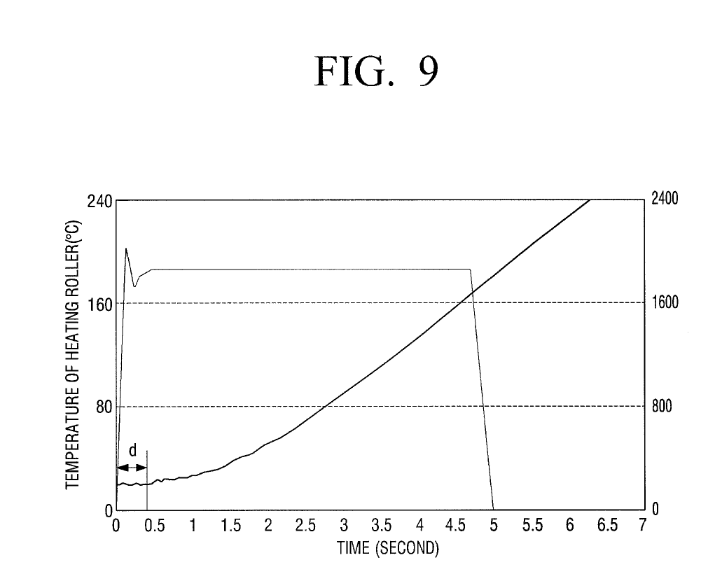

FIG. 9 is a graph illustrating a measured result with regard to a heating power variation of a heater and a temperature variation of the heating roller 212 according to a second embodiment. The structure of the heater according to the second embodiment is the same as the preceding exemplary embodiment and the rated heating power is varied to be 2100 W. Here, the rated heating power of the first heating element 210 is designed as 1300 W, and the rated heating power of the second heating element 220 is designed as 800 W.

The experimental result of FIG. 9 shows a similar pattern to that of FIG. 7. However, in the second embodiment, the rated heating power of the heater is high, so the temperature rise speed of the heating roller 121 is quickened. Also, the delay time (d) from the power supply time to the staring time of the temperature rise of the heating roller 121 takes about 0.45 seconds which is quickened about 0.05 seconds compared to the exemplary embodiment.

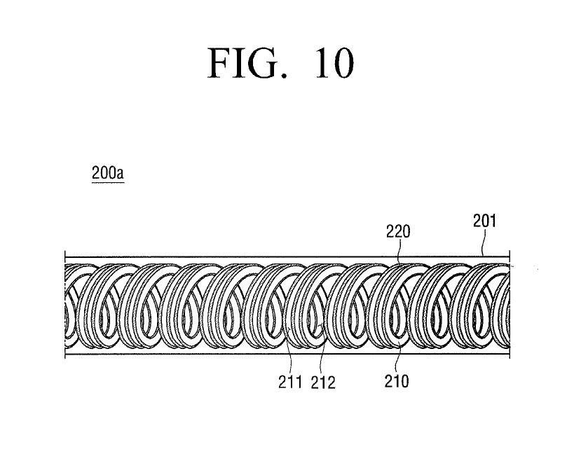

FIG. 10 schematically illustrates a heater 200a according to a third embodiment. The same functional components as in the exemplary embodiment are given with the same reference numbers and their detailed descriptions are omitted.

The difference between the third embodiment and the exemplary embodiment is that the coupling members 240 are omitted. Instead, the second heating element 220 is joined to the first heating element 210 and to do this, various ways of the bonding process may be executed. However, it is the same thing with the exemplary embodiment that the second heating element 220 is extended along with the progress direction of the coil of the first heating element 210. In the exemplary embodiment, in a section where no coupling elements exist, a fine gap may be formed between the first and second heating elements 210 and 220. However, in the third embodiment, the second heating element 220 is joined to the first heating element 210, so the second heating element 220 is attached to the first heating element 210 entirely. Accordingly, at the initial stage of the power supply to the heater 200a, a great amount of the heat generated by the second heating element 220 may be used to heat the first heating element 210. As a result, resistance of the first heating element 210 may be reduced rapidly and the first heating element 210 may reach the highest heating power more quickly.

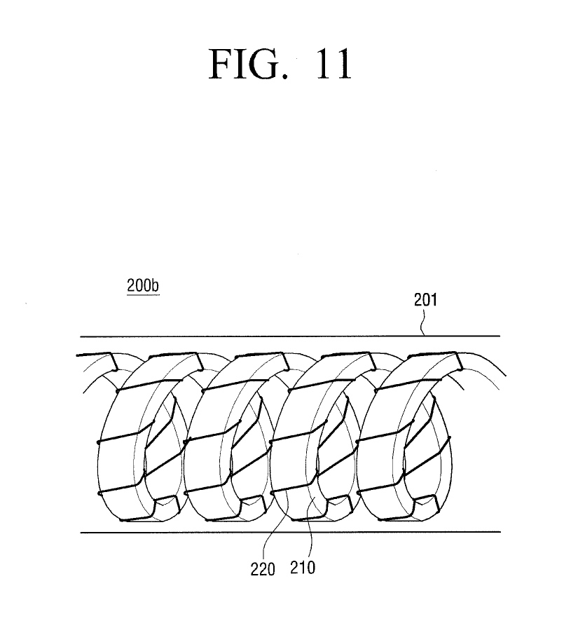

FIG. 11 schematically illustrates a heater 200b according to a fourth embodiment. The same functional components to the exemplary embodiment are given with the same reference numbers and their detailed descriptions are omitted.

In fourth embodiment, the second heating element 220 is wound surrounding the coil of the first heating element 210. By the frictional force between the first and second heating elements 210 and 220, the second heating element 220 may be fixed at a right position. Accordingly, an additional coupling member or a separate connection process is unnecessary.

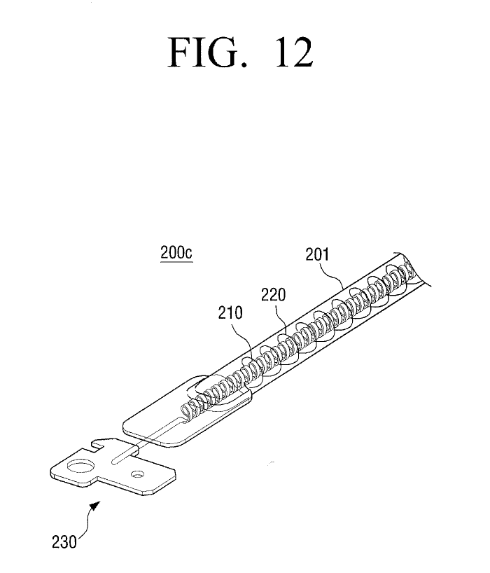

FIG. 12 schematically illustrates a heater 200c according to a fifth embodiment. The same functional components to the exemplary embodiment are given with the same reference numbers and their detailed descriptions are omitted.

In the fifth embodiment, the second heating element 220 forms a coil in the bulb 201 like the first heating element 210. The coil of the first heating element 210 is placed inside the coil of the second heating element 220. The difference between the preceding embodiments and the fifth embodiment is that the second heating element 220 is distant from the first heating element 210. If the radiant heat generated by the second heating element 220 heats the first heating element 210 to reduce resistance of the first heating element 210 at the initial stage of the power supply to the heater 200c. To heat the first heating element 210, the second heating element 220 should not be placed far away from the first heating element 210 and it is desirable to place the second heating element 220 to be adjacent to the first heating element 210. In order to heat the first heating element 210 evenly by the second heating element 220, it is desirable to have the same coil axis between the coil of the first heating element 210 and the coil of the second heating element 220.

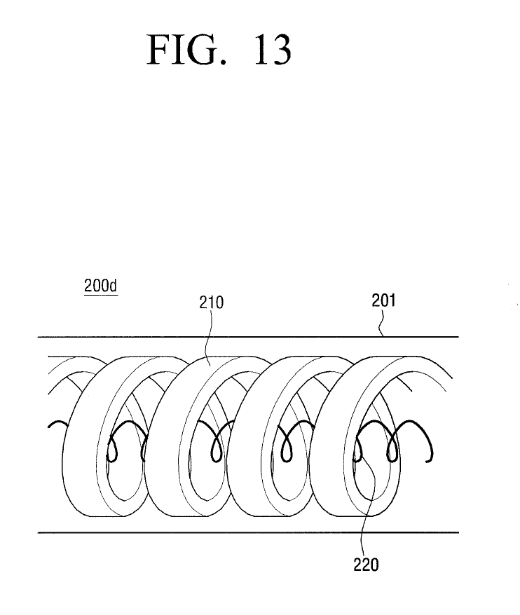

FIG. 13 schematically illustrates a heater 200d according to a sixth embodiment. The same functional components to the exemplary embodiment are given with the same reference numbers and their detailed descriptions are omitted.

The sixth embodiment is similar to the fifth embodiment from the view point that the second heating element 220 forms the coil in the bulb 201. However, in the sixth embodiment, the coil of the second heating element 220 is placed inside the coil of the first heating element 210. To heat the first heating element 210 evenly by using the second heating element 220, it is desirable to have the same coil axis between the coil of the first heating element 210 and the coil of the second heating element 220.

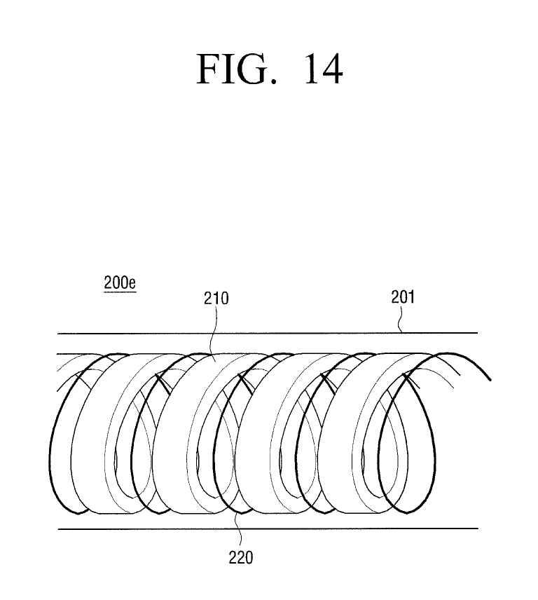

FIG. 14 schematically illustrates a heater 200e according to a seventh embodiment. The same functional components to the exemplary embodiment are given with the same reference numbers and their detailed descriptions are omitted.

In the seventh embodiment, the coil of the first heating element 210 and the coil of the second heating element 220 keep the same coil radius and the same coil axis. However, the coil of the second heating element 220 is placed to be offset from the coil of the first heating element 210.

In the previous embodiments, the rated heating power of the heaters 200, and 200a-200e are set as 1300 W and 2100 W. However, that is merely an example only and the rated heating power of the heaters 200 and 200a-200e may be between 600 W and 3000 W. Even if the rated heating power of the heaters 200 and 200a-200e varies, the rated heating power of the first heating elements 210 will be set higher than the rated heating power of the second heating element 220 to prevent the occurrence of the excessive inrush current.

The following is the arranged table of the experimental results for the first to seventh embodiments and the standard embodiment.

TABLE 1

| | | | | Access | | | | |
|---|---|---|---|---|---|---|---|---|
| | Rated | Actual | | time to | | Relative | Temperature | Improvement |
| | heating | heating | Delay | maximum | Temperature | ratio of | rise speed | ratio of |
| | power | power | time | power | rise speed | temperature | per KW | heating |
| | (W) | (W) | (s) | (s) | (° C./s) | rise speed | (° C./s · KW) | performance |
| Standard | 1300 | 1125 | 2.50 | 3.60 | 20.0 | 1.00 | 18 | 1.00 |
| embodiment | | | | | | | | |
| Embodiment1 | 1300 | 1150 | 0.50 | 0.60 | 28.0 | 1.40 | 24 | 1.37 |
| Embodiment2 | 2100 | 1860 | 0.45 | 0.55 | 40.5 | 2.02 | 22 | 1.22 |
| Embodiment3 | 1300 | 1160 | 0.45 | 0.55 | 29.0 | 1.45 | 25 | 1.40 |
| Embodiment4 | 1300 | 1149 | 0.50 | 0.60 | 28.0 | 1.40 | 24 | 1.37 |
| Embodiment5 | 1300 | 1128 | 1.00 | 1.50 | 26.0 | 1.30 | 23 | 1.29 |
| Embodiment6 | 1300 | 1130 | 1.20 | 1.80 | 24.0 | 1.20 | 21 | 1.19 |
| Embodiment7 | 1300 | 1139 | 0.85 | 1.65 | 27.0 | 1.35 | 24 | 1.33 |

In the above table, the delay time indicates the time from the power supply time to the heater to the starting time of the temperature rise of the heating roller. The access time to the maximum power indicates the time taken for the heating power of the heater to reach up to a 97.7% level of the measured maximum heating power.

It may be observed that the embodiments 1 to 7 greatly shorten the delay time and the access time to the maximum power compared to the standard embodiment. The embodiments 1 to 4 in which the second heating element 220 contacts the first heating element 210 show the better results since the second heating element 220 contacts the first heating elements 210 and this causes that a greater amount of heat is used to heat the first heating element 210 to reduce resistance of the first heating element 210 more quickly.

The temperature rise speed indicates the increased temperature per unit time of the heating roller. According to the experimental result, the temperature of the heating roller increases in a linear shape in the temperature sections between 50° C. and 180° C. It may be observed that all of the embodiments 1 to 7 are improved in temperature rise speed compared to the standard embodiment. There is not much deviation among the first to seventh embodiments in the temperature rise speed. It is owing to the reason that the resistance reducing effect of the first heating element 210 through the second heating element 220 which heats the first heating element 210 affects greatly at the initial stage of the power supply to the heater. That is, in the event that the temperature of the heating roller is in a 50° C. to 180° C. range, regardless of any specific embodiments, resistance of the first heating element 210 is kept low while the first heating element 210 is heated at a high temperature, and resistance of the first heating element 210 does not show much deviation among the first to seventh embodiments. The temperature rise speed of the second embodiment shows a sharp increase as the rated heating power thereof is greater than the rated heating power in other embodiments.

The relative ratio of the temperature rise speed indicates a value in which the temperature rise speed of each embodiment is divided by the temperature rise speed of the standard embodiment. For example, if the temperature rise speed of the standard embodiment is 20.0° C./s and the temperature rise speed of the first embodiment is 28.0° C./s, the relative ratio of the temperature rise speed of the first embodiment becomes 1.40 (=28.0/20.0).

The temperature rise speed per KW means that the temperature rise speed is divided by the measured heating power (KW). As the rated heating power of the second embodiment is higher than the other embodiments, the temperature rise speed per KW is introduced to compare the second embodiment with the other embodiments under the same condition. For example, if the temperature rise speed of the exemplary embodiment is 28.0° C./s and the actual heating power is 1.115 KW, the temperature rise speed per KW of the exemplary embodiment becomes 24 (=28/1.115)° C./s·KW.

The improvement ratio of the heating performance indicates a value in which the temperature rise speed per KW of each embodiment is divided by the temperature rise speed per KW of the standard embodiment.

Although there are some differences in a degree among the embodiments, it may be observed through Table 1 that the delay time, the access time to the maximum power, and the temperature rise speed may be improved compared to the standard embodiment. Accordingly, the present embodiments achieve the fast FTOP. Moreover, even if the heating power of the heaters 200 and 200a-200e are raised, the excessive inrush current may be prevented since the first heating element 210 which keeps high resistance at a normal temperature exists and the heating power allotted to the first heating element 210 which keeps high resistance at a normal temperature is larger than the heating power allotted to the second heating element 220 which keeps low resistance at a normal temperature.

As a result, even if one of the heaters 200 and 200a-200e is disposed in the heating roller 121, the fast FTOP may be achieved without the excessive inrush current and thus, it could be helpful to minimize the size of the fixing apparatus.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A heater for a fixing device to provide heat to a printing medium, comprising:
a bulb;
a first heating element which has a negative temperature coefficient of resistance and a first rated heating power and forms a first coil in the bulb; and
a second heating element which has a positive temperature coefficient of resistance and a second rated heating power that is lower than the first rated heating power and is disposed in the bulb, wherein
the second heating element is placed adjacent to the first heating to heat the first heating element at an initial stage of a power supplying to the heater, thereby reducing resistance of the first heating element.

2. The heater as claimed in claim 1, wherein the first heating element comprises a carbon filament, and the second heating element comprises a tungsten filament.

3. The heater as claimed in claim 1, wherein the second heating element comprises plural filaments which contact the first coil of the first heating element and extend along with a progress direction of the first coil of the first heating element in parallel to one another.

4. The heater as claimed in claim 1, further comprising plural coupling members to attach the second heating element to the first heating element.

5. The heater as claimed in claim 4, wherein the plural coupling members are disposed along with the progress direction of the first coil of the first heating element.

6. The heater as claimed in claim 1, wherein the second heating element is joined to the first heating element.

7. The heater as claimed in claim 6, wherein the second heating element extends along with the progress direction of the first coil of the first heating element.

8. The heater as claimed in claim 1, wherein the second heating element is wound around the first coil of the first heating element.

9. The heater as claimed in claim 1, wherein the second heating element forms a second coil in the bulb.

10. The heater as claimed in claim 9, wherein the first coil is disposed in the second coil.

11. The heater as claimed in claim 9, wherein the second coil is disposed in the first coil.

12. The heater as claimed in claim 9, wherein the first coil and the second coil have a same coil axis.

13. The heater as claimed in claim 12, wherein the first coil and the second coil have a same coil radius, and the second coil is placed to be offset from the first coil along with the coil axis.

14. The heater as claimed in claim 1, wherein heating power of the heater is approximately between 600 W and 3000 W.

15. The heater as claimed in claim 1, wherein a first rated heating power of the first heating element is approximately 800 W, and a second rated heating power of the second heating element is approximately 500 W.

16. The heater as claimed in claim 1, wherein the first heating element and the second heating element are electrically connected to each other in parallel.

17. The heater as claimed in claim 1, wherein the first heating element and the second heating element are electrically connected to each other in series.

18. The heater as claimed in claim 1, wherein the bulb is formed of quartz glass in a cylindrical shape and sealed with an inactive gas therein.

19. A fixing device, comprising:
a pressing unit; and
a heating unit, the pressing unit being pressed towards the heating unit by an elastic member,
wherein the heating unit includes a heating roller and a heater according to claim 1.

20. An image forming apparatus, comprising:
a feeding apparatus to accommodate a printing medium;
a plurality of supplying rollers to transfer the printing medium is transferred through a progress course;
a charging apparatus to charge a photoreceptor by a predetermined electric potential;
a light scanning apparatus to form an electrostatic latent image on the photoreceptor which corresponds to a printing data by scanning a light to the photoreceptor;
a developing apparatus to form a toner image by supplying the toner to the photoreceptor;
a transferring apparatus to transfer the toner image which is formed at the photoreceptor to the printing medium;
a cleaning apparatus to remove the toner which is remained at the photoreceptor after the transferring process is completed;
a fixing device according to claim 19 to fix the unsettled toner which is located on the printing medium by applying the heat and the pressure onto the printing medium.
